(19) United States
(12) Patent Application Publication
(10) Pub. No.: US 2019/0352967 A1
(43) Pub. Date: Nov. 21, 2019

(54) Universal vane actuator system with corner seals and differential rotation mechanisms

(71) Applicant: Jianchao Shu, Cypress, TX (US)

(72) Inventor: Jianchao Shu, Cypress, TX (US)

(21) Appl. No.: 16/443,824

(22) Filed: Jun. 17, 2019

Related U.S. Application Data
(60) Provisional application No. 62/671,989, filed on May 15, 2018.

(51) Int. Cl. E21B 4/02; E21B 7/06; E21B 21/08; F01D 17/16

(52) U.S. Cl. CPC E21B 4/02; E21B 7/067; F15B 15/12; F01D 17/16; E21B 21/08

(57) ABSTRACT

This invention relates to a versatile rotary vane actuator module and a thermal actuation system with universal adaptable shafts/installation and differential rotary and turbocharger mechanisms to actuate 0-360 degree or more for complicated, precision, extreme rotary applications like robotic excavators, airplanes, heavy or weapon machinery, satellite receivers or wind turbine position controls, remote pipeline valves, HIPP or subsea valves and BOP controls, the thermal actuation system includes three thermal elements (1) pressure sources (2) volume vessel (3) heat sources, the vane actuator comes with redundant edge seals and corner seal rings to minimize or eliminate the inherent leakage and the differential rotation mechanism and the turbocharger with a dynamic porting system to expand the rotation 360 degree more efficiently, the actuator module includes a least one housing assembly, at least one driver assembly and at least one dynamic embedded porting system.

### CROSS-REFERENCE TO RELATED APPLICATION

This application claims the benefit of provisional patent application Ser. No. 62/671,989 filed on Jun. 25, 2018 by the present inventor.

### FEDERALLY SPONSORED RESEARCH

No

### SEQUENCE LISTING OR PROGRAM

No

### BACKGROUND

This invention relates to a versatile, rotary vane actuator module and a thermal actuation system with universally adaptable installation and operation for any position and one to more output driving shafts rotating 0-360 degree or more for complicated, precision or extreme rotary applications like robotic excavators, airplanes, heavy or weapon machinery, satellite receivers or wind turbine position controls, remote pipeline valves, HIPP or subsea valves and BOP controls, the thermal actuation system includes three thermal elements (1) pressure sources (2) volume vessels (3) heat sources, the rotary vane actuator module comes with redundant edge seal rings and corner seal rings to minimize or eliminate the inherent leakages for precision position control and differential rotation and turbocharge mechanisms with a dynamic porting system to expand the rotation beyond 360 degree for complicated control applications, the actuator module includes at least one housing assembly, at least one driver assembly and a dynamic embedded porting system, the actuator module is used as one unit for driving valve or single shaft rotation machines, two or three of combination of the unit can provides two or three direction of rotations for excavators or earth moving equipment or airplane control to greatly simplify the complicated control system with 6 to 8 linkage mechanism to a simple two three dimension rotation control with 48% energy over the conversational excavator or earth moving equipment, this actuator module not only eliminates the conventional vane leakage issue, but also provides rotation beyond 360 degree limitation for the first time with the differential rotation mechanism, moreover the dynamic porting system not only provides multiple link porting system to reduce uneven speed of vanes and to control complicated motion like combination or sequel manners but also has redundant porting exit and entry under stationery or dynamic conditions among the actuator modules, which provide great joint flexible and eliminate external hydraulic hose or pneumatic tubing for interconnection in two or three dimension motion control among the actuator modules, the interconnection cause the most leaks or failure for most of 2D or 3D actuation, finally the thermal power supply and the turbocharger unit revolutionize the actuation system for all rotary applications in any location or position.

The conventional vane actuators on the all related prior arts have come with nine inherent problems over more than 100 years (1) high leakage at corners as well as top and bottom surfaces, so far there is no good solutions, some vane actuator has a single vane with large radial corners, but due to lager side load and cross side vane engagement and top and bottom leaks, the leakage still presents big challenges for precision volume control or position applications (2) side load, single vane actuator can ease leakage issue but creates unbalanced side load on the shaft as well as the vane and greatly reduce product life and efficiency and cause shaft leakage prematurely (3) limitation of rotation, unlike helical or rack/pinion rotary actuators, most vane actuator has limit of the rotation angle from 60 with three vanes to 280 degrees with one vane, for examples single vane actuator cannot reach 360 degree or two-vane actuator cannot reach to 180 degree (4) lack of stiffness of moment, because the vane actuator has no linear to rotation converting mechanism, so it has very low stiffness of movement or holding torque in comparison with rack and pinion actuators or helical actuator and is not suitable for those operations of precision position with constant pressurized fluid (5) lack of relative position control, for precision rotation control like valve control, satellite receiver controls or wind turbine direction controls, as well as subsea valve control systems, the position adjustment is very important, but 99% of the adjustments are relative position control between a rotary shaft and an installing flange plate between 90 degree with a float start point not absolute position control between 0-90 degree (6) lack of modulation design and adaptability, for two or three dimension motion control, two or three actuators are needed, but there is no optimized joint method for conventional actuators, In order to meet ISO 2511, many manufacturers have to make various shaft adapters to meet the ISO 2511 shaft types (7) lack of method for full stroke test, the partial stroke tests miss critical part of the stroke which is closed to full closed positions which the torque increase greatly, so it is never reliable solution. So far no rotary valve actuator can be tested for full stroke test without changing a valve operation condition (8) lack of robust, versatile porting systems, most of the porting systems are static, only for one or two cavities, such the porting system cannot run complicated operations like sequence operations, speech control by selecting number of active cavities 1, 2, or 3 . . . N, most of 2D or 3D actuators are equipped with external hose or tubing for the interconnection among the actuation models, the interconnections cause the most of leaks and failure due to harsh working conditions, corrosion or accident hits and is the weakest link in the actuation system, moreover for most fast shut off valve or fast cycled valves, the fast closing actuation is an eternal struggle, with the speech less than one or two seconds, the valve seat and packing were damaged and replaced constantly even every operation, while with less than one or two seconds speech, like LNG terminal shutoff valves, they would be frozen and cannot be operated, or rocket engine fuel delivery system with fluid mixing of liquid oxygen and hydrogen, any wrong mixing can cause explosive or missing ignition, or like refiner or chemical plant shutoff valves, they can cause explosion, fire and release toxic gas and kill people (9) Heavy weights and large size, either single vane actuators or double vane actuators have higher weights of the housing and vanes, for high pressure, the vane actuators have the heavy, large housings with the thick walls for bolting as well as heavy, thick vanes, while for pneumatic low pressure, the single vane actuators have thick and heaver vane with multiple seal layers with the solid shaft and heavy and large housing with low strength of die aluminum and reinforced ribs, those vane actuators have the high purchasing cost due to very low torque density (torques/weights) and have high operation cost due to low fluid efficiency (torque/fluid volume) (10) Energy waste, most actuators operate with incoming high pressurized fluid from one port and release high pressurize fluid into other port in order to actuate the drive shaft, those operations waste great amount of high pressurized fluid into the releasing port never recycle the high pressurized fluid.

So the flow control industry has long sought means of improving the performance of the vane actuators, improving the seal, creating a robust actuation system under multiple extreme conditions.

In conclusion, insofar as I am aware, no such a system is formerly developed without the above limits or problems and manufactured at low cost.

### SUMMARY

This invention provides a simple, versatile vane actuator module and a thermal actuation system, the actuation system include at least one housing assembly, at least one dynamic porting system and at least one driver assembly, the housing assembly has a housing and top and a pair of top and bottom flange assemblies and at least one housing vane assembly, the drive assembly has at least one shaft vane assembly for generating output torque, the drive assembly has at least one pair of top and bottom removable covers placed on the van assemblies for securing joints between the shaft and shaft vanes with fasteners and create static seals, two internal corner seal rings and two external corner seal rings disposed respectively on groove of the shaft surface and grooves on a housing wall surface to provide corner seals between the shaft vanes and the housing vanes, each vanes has two edge grooves with two seal rings for providing seals among the covers, the housing vanes and the shaft vanes, the porting system has at least one of the porting link systems, which includes a radial porting system, axial porting system and central porting system, the shaft packing not only provides additional shaft seal, but also supports heavy shaft side load and control shaft motion stiffness based on various holding torques requirements. The thermal actuation system also includes three elements (1) pressure sources (2) volume vessels (3) heat sources and, it also can be powered by hydraulic or pneumatic sources to actuate the vane rotary movements.

Accordingly, besides objects and advantages of the present invention described in the above patent, several objects and advantages of the present invention are:
(a) To provide high sealable vane actuator, such an actuator can be used for highly precision volume or position control applications.
(b) To provide a vane actuator without limitation of rotation and side loads, so the actuator can used for any rotary angle application.
(c) To provide an actuator with controllable stiffness, so the actuator has an adjustable stiffness device for position holding applications, so the actuator can adaptor various applications with various stiffens efficiently unlike the conventional vane actuator which have no workable holding capability with no converting frication or helical actuators which have high unnecessary holding force and waste energy due to the high converting frication.
(d) To provide a reliable actuation system, so the system can conduct full stroke test without changing valve operation conditions unlike the partial stroke test, the partial stroke test miss critical part of the stroke which is either closed to full open or closed positions, so it is never reliable solution.
(e) To provide a actuator with multiple, dynamitic porting system, so the multiple porting vane actuator not only has evenly movements and loads for each vane, but also can provide various power sources for two or three dimension motion controls for higher reliable, complicated motion control applications.
(f) To provide a hybrid powered vane actuator, so both pneumatic and hydraulic powers can be used in one system, so the hydraulic vane provides the stiffness while pneumatic power provide pressure sources and fast actions, moreover powered air release without polluting water or air, or hydraulic power is broken down, the pneumatic power can be used or vice versa.
(g) To provide a highly efficient vane actuator, so the actuator has not only adjustable rotation and lager output torques with side load support, but also minimizes vane spaces and weight as well as releasing pressurized fluid and controllable stiffness for various loading toques applications.
(h) To provide a pressure protection system with pressure control actuators, so such a system can be equipped with regular full open and full closed valves with simple reliable control system at the low cost.
(i) To provide heating device for air reservoir, so the system can use less pressurized gas and reduce operation cost and increase reliability.
(j) To provide an actuation system with adaptable interfaces, so the actuators can be interconnected for 2D or 3D actuators and connected with various shaft joints without backlash or loss of motion for precision motion control.

Still further objects and advantages will become apparent from study of the following description and the accompanying drawings.

### DRAWINGS

FIG. 1 is an exploded, quarter cut view of a vane actuator module constructed in accordance with this invention.

FIG. 2 is a front view of actuator. of FIG. 1

FIG. 3 is a cross sectional view of actuator of FIG. 2 along line B-B.

FIG. 4 is a cross sectional view of valve of FIG. 2 along line E-E.

FIG. 5 is a cross sectional views of valve of FIG. 2 along line F-F.

FIG. 6 is a “H” detail view of valve of FIG. 3

FIG. 7 is a “J” detail view of valve of FIG. 3

FIG. 8 is an ISO view of wall vane assembly of FIG. 3

FIG. 9 is a “N” detail view of valve of FIG. 4.

FIG. 10 is a “K” detail view of valve of FIG. 3

FIG. 11 is a front view of an alternative actuator module assembly of FIG. 1.

FIG. 12 is a cross sectional view of the actuator module assembly of FIG. 11 along line A-A.

FIG. 13 is a cross sectional view of the actuator module assembly of FIG. 11 along line B-B.

FIG. 14 is a front view of an alternative actuator module assembly of FIG. 11.

FIG. 15 is a cross sectional view of the actuator module assembly of FIG. 14 along line A-A.

FIG. 16 is a cross sectional view of the actuator module assembly of FIG. 14 along line B-B.

FIG. 17 is a front view of an alternative actuator module assembly of FIG. 1.

FIG. 18 is a cross sectional view of the actuator module assembly of FIG. 17 along line L-L.

FIG. 19 is a cross sectional view of the actuator module assembly of FIG. 18 along line M-M.

FIG. 20 is a cross sectional view of the actuator module assembly of FIG. 18 along line N-N.

FIG. 21 is a top view of a shutter valve of FIG. 18.

FIG. 22 is a cross sectional view of the actuator module assembly of FIG. 21 along line J-J.

FIG. 23 is a front view of an alternative actuator module assembly of FIG. 1.

FIG. 24 is a cross sectional view of the actuator module assembly of FIG. 23 along line C-C.

FIG. 25 is a cross sectional view of the actuator module assembly of FIG. 23 along line A-A.

FIG. 26 is a “E” detail view of valve of FIG. 24.

FIG. 27 is a “F” detail view of valve of FIG. 23.

FIG. 28 is a “J” detail view of valve of FIG. 24

FIG. 29 is a “B” detail view of valve of FIG. 25

FIG. 30 is an ISO view of an adjustable packing bearing device of FIG. 29.

FIG. 31 is an ISO view of an quarter cut view of shaft adapter assembly of FIG. 29.

FIG. 32 is an ISO, quarter cut view of a hybrid high integrity pressure protection system with the vane actuator module in FIG. 1.

### DESCRIPTIONS

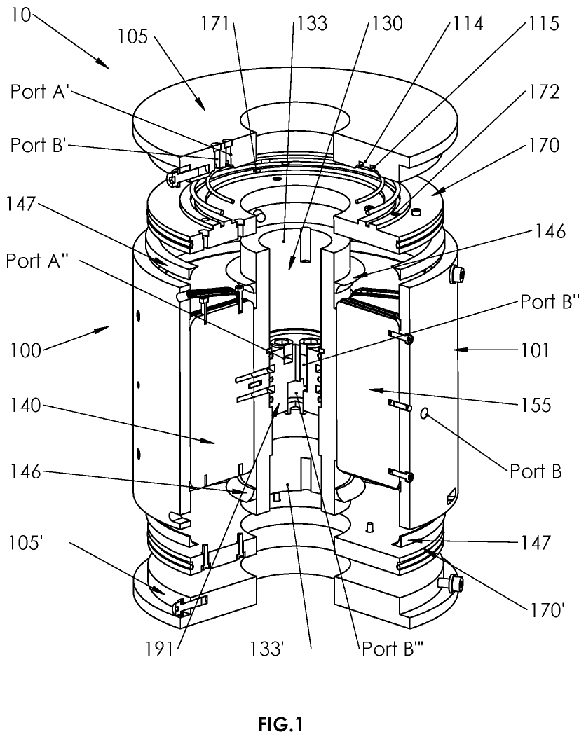

FIG. 1 illustrates a vane actuator module 10 constructed in accordance with the present invention, the actuator module 10 has a first housing assembly 100, a fluid power porting system for delivering pressurized fluids and a first drive assembly 130 disposed in the first housing assembly 100, the first housing assembly 100 has a first housing 101, a first flange assembly 105 with a porting and a first flange assembly 105′ without a porting and three housing vanes assemblies 155, the first drive assembly 130 has a pair of removable covers 170,170 installed on a bottom and top of three shaft vanes assemblies 140 respectively engaged with three housing vanes assemblies 155 for providing output torque by means of a top output adapter 133′ and output adaptor 133′.

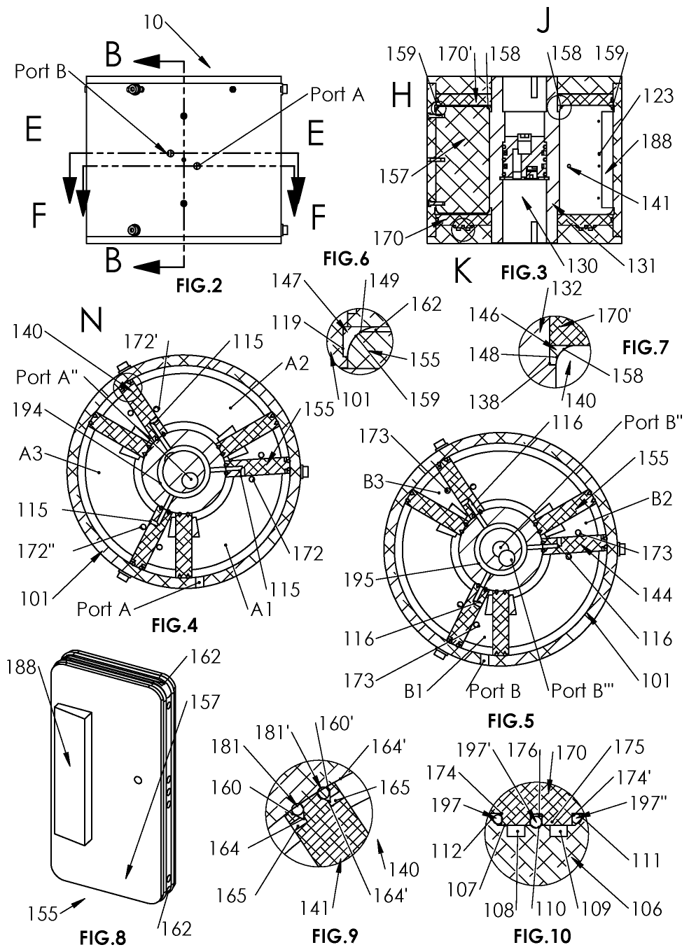

Referring FIGS. 1-10, the first drive assembly 130 has a shaft assembly 131, three shaft vanes assemblies 140 respectively fastened with shaft assembly 131 radially, a pair of top and bottom removable covers 170,170′ respectively secured with top and bottom of the shaft vane assemblies 140 and movably disposed on the housing vane assemblies 155 and two internal corner seal rings 146 and two external corner seal rings 147, the shaft assembly 131 has a shaft 132, the output adapters 133,133′ respectively installed on the top and bottom of the shaft assembly 131 as an integral unit or an assembly unit, three housing vanes assemblies 155 respectively engaged with shaft vane assemblies 140 for generating reactionary and active torques, the housing vanes assemblies 155 are installed with the housing 101 internally, a pair of top and bottom covers 170,170′ secured with top and bottom of the shaft vane assemblies 140 and movably disposed on top and bottom of the housing vane assemblies 155, since shaft vanes assembly 140 and the housing vane assembly 155 have the similar features, so the common features are detailed here for both vanes assemblies 155 and 140, each of the housing vane assemblies 155 has two seal rings 181,181′ and a vane 157 and two stop pads 188 to restrict absolute rotations between the shaft vane assembly 140 and the housing vane assembly 155, the vane 157 is defined by two internal radius surfaces 158, two external radius surfaces 159, two V seal grooves 160,160′ constructed around an edge of the vane 157 respectively to receive seal rings 181,181′ for separating the V seal grooves into two sections: an upper section 164 providing seals between the housing vane assembly 155 and shaft vane assemblies 140 and a down section 165 expanding to multiple like holes 165 for pressure energized seals, two pressure equalized grooves 162 are respectively constructed on a top and a bottom of the vane 157 for eliminating or minimizing crossover fluid leaks during rotation of the covers 170. 170′, each of the shaft vane assembly 140 has two seal rings 181,181′ and a shaft vane 144 with two seal rings 181,181′ for providing seals like the housing vane assembly 155, the vanes 144,157 are respectively defined by two internal radical surface 158 and two external radical surface 159, two grooves 138 are defined by the shaft 132, covers 170, 170′, a shaft vane 144, each of the two internal corner seal rings 146 respectively disposed in groove 138 has a mated radical surface 148 engaged with radical surface 158 for providing internal corner seals, two grooves 119 are respectively defined by the covers 170, 170′, the housing vane 155 and the housing 101, each of the two external corner seal rings 147 respectively disposed in the groove 119 has a mated radical surface 149 engaged with the radical surface 159 for providing external corner seals.

The porting system has a radical A/B porting system, an axial A′/B′ porting system and a center A″/B″, B″′ porting system 191 having port A″ and port B″, port B″′ with three plugs, retaining ring 109 and two top plugs blocked axial ports A′, B′, the porting system has a port line A having port A, port A′, port A″, three cavities A1,A2, A3 respectively defined by right sides of the housing vanes 155, left sides of the shaft vane assemblies 140, the shaft assembly 131, covers 170,170′ and housing 101, the port A is connected to cavities A1, A2,A3 through holes 172,172′, 172″ of the cover 170 to groove 109 and to port A′, the port A is connected to cavities A1,A2,A3 through three “L” passages 115 to groove 194 and to port A″, the porting system has a port line B with a port B, port B′, port B″, port B″′ and three cavities B1, B2, B3 respectively defined by left sides of the housing vane assemblies 155, right sides of the shaft vane assemblies 140, the shaft assembly 131, covers 170, 170′ and the housing 101, the port B is connected to cavities B1, B2, B3 through three holes 173 of the cover 170 to groove 108 and to port B′, the port B is connected to cavities B1, B2, B3 through three “L” passages 116 to groove 195 and to ports B″ and B″, the porting flange assembly 105 has a seal groove 107 defined by an internal conical surface 112 and an internal conical surface 111, a spherical groove 110, link grooves 108, 109, three seal rings 197,197′,197″, the cover 170 engaged with the seal groove 107 has steps 174,174′ and a groove 176, two seal rings 197, 197″ are respectively disposed between internal conical surface 112 and steps 174, between internal conical surface 111 and step 174′ for dynamic and static seals between the porting flange assembly 105 and the cover 170, the seal ring 197′ is disposed between the groove 110 and the groove 176 for providing dynamic and static seals between link grooves 108, 109, the center porting assembly 191 has a step 196 engaged with the drive assembly 130 and constricted by retaining ring 141, so the center porting assembly 191 can be used as dynamic port adapter even when the drive assembly 130 is rotated, a second drive assembly can be added axially as a turbocharge unit to take advantage of releasing pressurized fluid from port A or port B, because one port line A or B always has zero pressure, so such an operation would not result any slow down or high back pressure at the first drive assembly, the both shafts can be made out of one unit or an assembly unit in the first housing assembly, it can be added on other type of rotary actuators like rack and pinon, helical or scotch yoke actuators.

Referring FIGS. 1-13, a differential rotation module 20 has a second housing assembly 200 with an external porting ring assembly 201′, a first drive assembly 130′ for providing first rotations and a second drive assembly 230 is constructed with the first housing assembly 100′ as one integral unit or as a two-module assembled unit, the second drive assembly 230 has a shaft assembly 231 for adding additional rotation over the internal rotation of the first drive assembly 130′, disposed in the second housing assembly 200 for providing output torques along with the first drive assembly 130′, the second housing assembly 200 has also two of the second flange assemblies 205,205′ constructed respectively with the first flange assembly 105, 105′ as one integral unit or as a two-module assembled unit, three housing vane assemblies 255 respectively engaged with three shaft vanes assemblies 240 radially for generating external reactional and active torques, the shaft vane assemblies 240 installed with the shaft assembly 231 externally are respectively engaged with three housing vanes assemblies 255 for providing external output torques.

The porting system has a port line A with the port A, port A′ and port A″, three cavities A4, A5, A6 respectively defined by right sides of the housing vane assemblies 255, left sides of the shaft vane assemblies 240, the port A is connected to cavities A 4, A5,A6 through a link groove 202 of external porting assembly 201′ and ports 203,203′ and 203″, the cavities A4, A5, A6 are respectively connected with the 130′ drive assembly through three “Z” passages 242, 242′, 242″ into cavities A1,A2,A3, the porting system also a port line B with a port B, port B′, port B″, port B″′, three cavities B4, B5, B6 respectively defined by left sides of the housing vane assemblies 255, right sides the shaft vane assemblies 240, the port B is connected to cavities B4, B5, B6 through a link groove 204 of the link ring assembly 201 and ports 205,205′ and 205″, the cavities B4, B5,B6 respectively connected with the 130′ drive assembly through three “Z” passages 243, 243′,243″ into cavities B1,B2,B3.

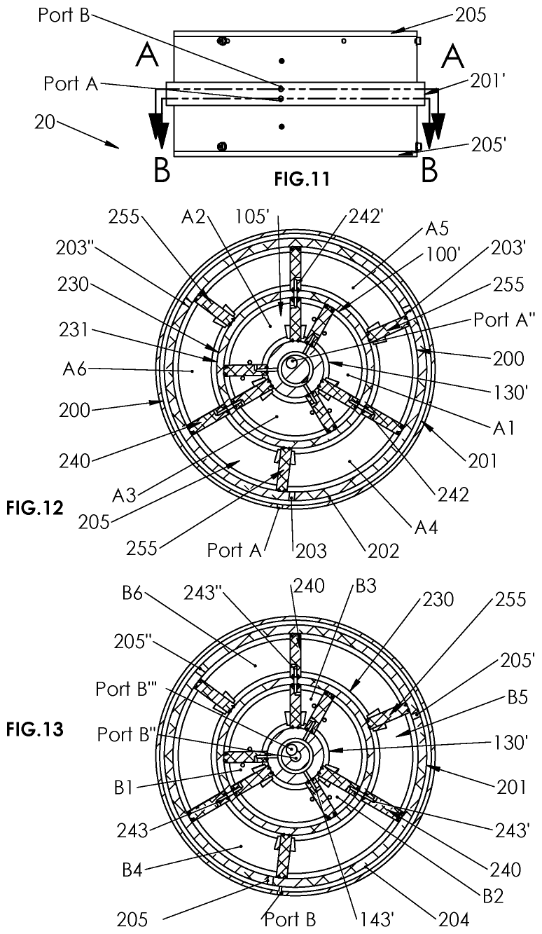

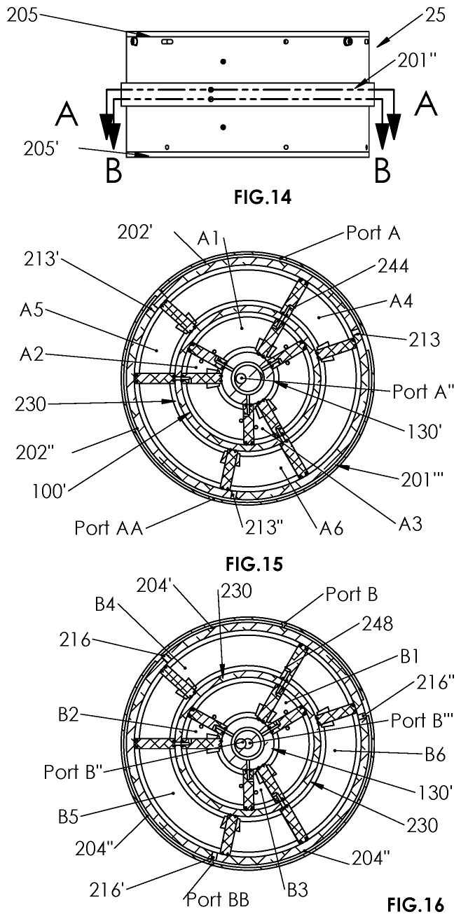

Referring FIGS. 11-16, a differential sequence module 25 is similar to module 20 only with a different posting system and has the second housing assembly 200 with an external porting ring assembly 201″, a first drive assembly 130′ for providing first output torques and a second drive assembly 230′ disposed in the second housing assembly 200 for providing the second output torques clockwise or anti-clockwise after the first drive assembly 130′ rotation, the second drive assembly 230 has a shaft assembly 231′, two shaft vanes assemblies 240, one porting shaft vane assembly 240′ and three wall vane assemblies 255, two shaft vanes assemblies 240, the one porting shaft vane assembly 240 respectively installed with the shaft assembly 231′ radially and respectively engaged with three housing vanes assemblies 255 for generating output torques from the first drive assembly 130′ then the second drive assembly 230′, the housing vanes assemblies 255 are installed with the housing 201 internally for providing reactional and active torques with the shaft vane assemblies 230′, 230″.

The porting system has a port line A with port AA, Port A, port A′, port A″, three cavities A4, A5, A6 respectively defined by right sides of the housing vanes 255, left sides of the shaft vane assemblies 240, the port A is connected to cavities A 4 through a first section link groove 202′ of the external porting 201″ and a hole 213 and through “Z” passage 244 into A1,A2 and A3 for actuating driving assembly 130′ or releasing fluids, the porting system has also a line B with the port B subsystem has port BB, port B, port B′, port B″, port B″′, three cavities B4,B5, B6 respectively defined by left sides of the housing vane assemblies 255, right sides the shaft vane assemblies 240, the port B is connected to cavities B4 through a link groove 204′ of the link ring assembly 201′ and through “Z” passage 248 into B1, then B2, B3 for actuating drive assembly 130′ or releasing fluids, the Port AA is connected with cavities A5, A6 through a section link groove 202″ of the external porting assembly 201″ and holes 213′ 213″, the Port BB is connected with cavities B5, B6 through a link groove 204′ of the link ring assembly 201′ and holes 216′, 216″, when Port A and Port B are used for actuating and releasing, cavities A5,A6 B5,B6 are not used, there is no power fluids in or out cavities A5, A6, B5, B6, so cavities A4 and B4 are used for porting purpose and would not drive the second drive assembly 230, only the first drive assembly 130′ moves as the first rotation, then once port BB with coming fluids is connected to the cavities B5, B6 through holes 216′ and 261″ respectively and the port AA is connected to cavities A 5, A6 through a section link groove 202″ of the external porting assembly 201″ and holes 213′,2013″, A4 is ready connected, the second drive assembly 230′ would rotate, as each cavities A5,A6, B5,B6 are respectively connected to the Port A subsystem and port B subsystem, so the second drive assembly 230′ can rotate independently with Port A and Port AA from the link ring assemble 201′ and without “Z” passage 244 and with Port B and Port BB from the link ring assemble 201′ and without “Z” passage 248, while the first drive assembly 130′ can rotate independently with port A′, port B″ or from port A″ and ports B″ or B″′, cavities A1, B1, A4, B4 can be used as independent control porting system for actuation or holding a position with liquid or gas.

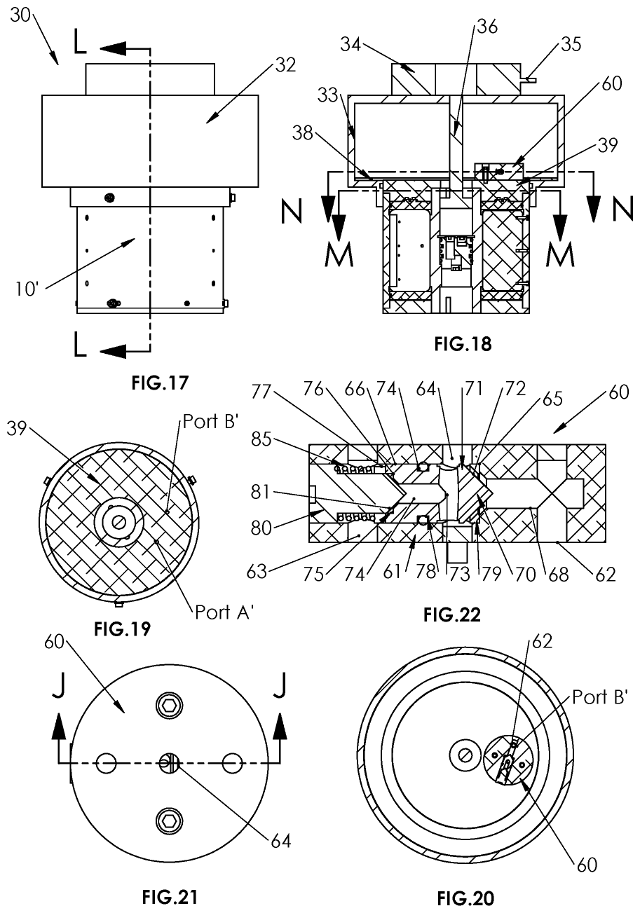

Referring FIGS. 17-22, a thermal actuation system 30 has a vane actuator module 10′ and an air reservoir assembly 32, the air reservoir assembly 32 has a shaft adaptor 36 disposed between actuator module 10′ and the air reservoir assembly 32 for indicating the rotation position of vane actuator module 10′ and a pressure vessel 33 disposed on the vane actuator module 10′ by means of a porting cover assembly 170″ for storing pressured air and a heat tracing 38 and a top gas burner 34 with a gas connected adaptor 35 for heating pressured air stored in the air reservoir assembly 32, the cover assembly 170″ has ports A′,B′ and a shutter valve 60 connected with ports A′, B′, shutter valve 60 has two positions; a front open/back closed and a front closed/back open, the shutter valve 60 has a body 61, a shutter assembly 70 and a back seat assembly 80 and a back seal ring assembly 75 against the back seat assembly 80, the body 61 has two bottom holes 62,63 respectively connected with Port A′, B′ and a release port 64 connected with the pressure vessel 33, as high pressure fluids come into port A and to port A′ pushes the shutter assembly 70 at the front open/back closed position, hole 62 is connected Part A′ and block between hole 63 and port B′, then the high pressure fluid flows into the air reservoir assembly 32 through port 64 and rotate module 10′ clockwise or anti clock wide, once high pressure fluids become lower pressure or no fluid in fluid at Port A and Port A′, the shutter valve 60 moves back to the front closed/back open position, hole 62 from port A, and hole 64 are blocked, while the release port 64 is connected with hole 63, the pressurized fluid in air reservoir assembly 32 flows into port B′ to rotate the model 10′ anti-clock wide or clockwise as an air return instead of spring return (a solenoid valves open Port A and closed port B not shown), the body 61 has also a main bore 68 expanding to the hole 62, a front seat step 65 and a link bore 73 linking to hole 74, the shutter assembly 70 has a shutter 71 and a seal ring 78 and a back seat 75, the shutter 71 has a front conical surface 72 against the front seal ring 79 for seals the back adjustable seat assembly 80 has a spring 85 biased against shutter 71 and the fluid pressures on the hole 68 for creating a preset pressure, the seal ring 78 disposed between the bore 66 and shutter 71 for generating piston effect against the spring 185, the shutter 71 has a center hole 74 expanding to multiple side holes 73 and to and multiple back slots 77.

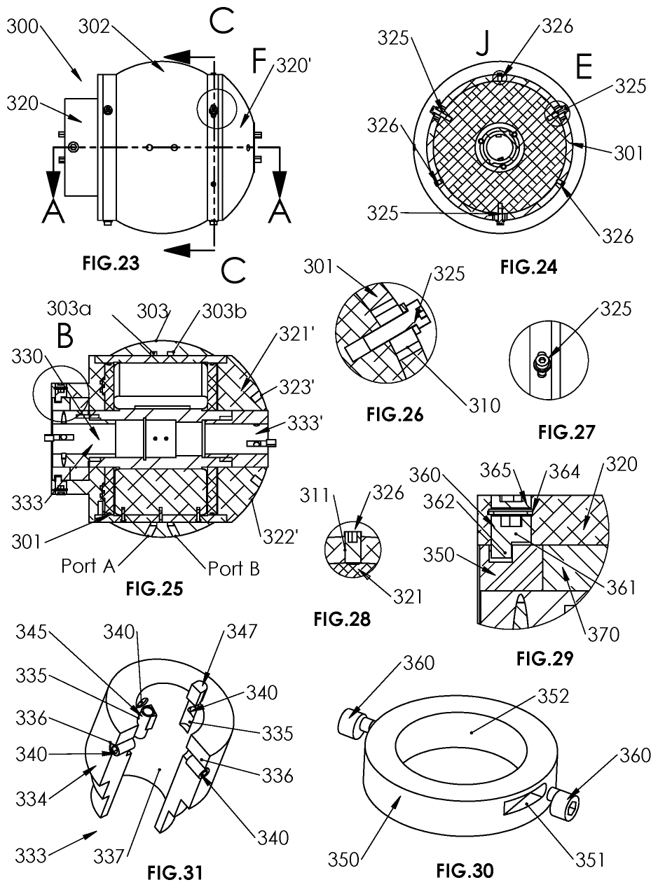

Referring FIGS. 23-31, an universally adaptable vane actuator module 300, the vane actuator has a flange assembly 321′, a housing assembly 301 and a drive assembly 330, the housing assembly 301 has a port linked ring 302 with Port A, port B having a spherical surface 303 for supporting the actuator 300 vertically with heavy weights of machinery like the excavator center compartment or combining with a second or third vane actuators 300 with fluid porting connections for 2 D or 3 D motion operations, the flange assembly 321′ has a spherical interface 323′ for supporting side loads from vane shaft adapter 330 when the actuator module 300 is installed horizontally, the flange assembly 321 and the housing assembly 301 have three screw/wash sets 310 for relative position adjustments between the flange assembly 321 and the housing assembly 301 and three setscrew 315 set with high frication structures on the flange assembly 321′ for locking the relative position adjustments, the housing assembly 301 has three slots 307 to receive the screw sets 310 for adjusting a relative position for +/−15 degrees or more, the drive assembly 330 has a shaft adapter assembly 333 having three external cylindrical slots 333 for coupling with the drive assembly 330 with three pins (not shown), so the drive assembly 330 can be coupled with various shafts joints without changing whole vane actuators 300, the shaft adapter assembly 333 has also three internal pin slots 355 coupled with output drive shafts and three pins (not shown) for pin/key shaft joints with pin 345 and key adapter 347, so if a shaft comes with a pin slot joint, the pins 345 would be used, if a shaft comes a key way joint, the key adapt 347 and pin 345 would be used, the shaft adapter assembly 333 has also three setscrews 340 respectively disposed in the holes 336 for a double D joint or square head shaft joints, finally adaptable vane actuator module 300 has a packing assembly 320, the packing assembly 320 has a lock bearing assembly 350 and a packing 370, the lock bearing assembly 350 has two horizontal slots 351 and two eccentric plugs 360, the eccentric plugs 360 has a driving cylinder 316 disposed in the housing assembly 301 and eccentric cylinder 362 engaged with the slot 351, when the driving cylinder 316 rotates, the eccentric cylinder 362 would push the lock bearing assembly 350 up and down against the packing 370 for adjusting frictions against the drive assembly 330, a retainer ring 364 and a setscrew 365 are installed for preventing the eccentric lock plug 343 from falling out.

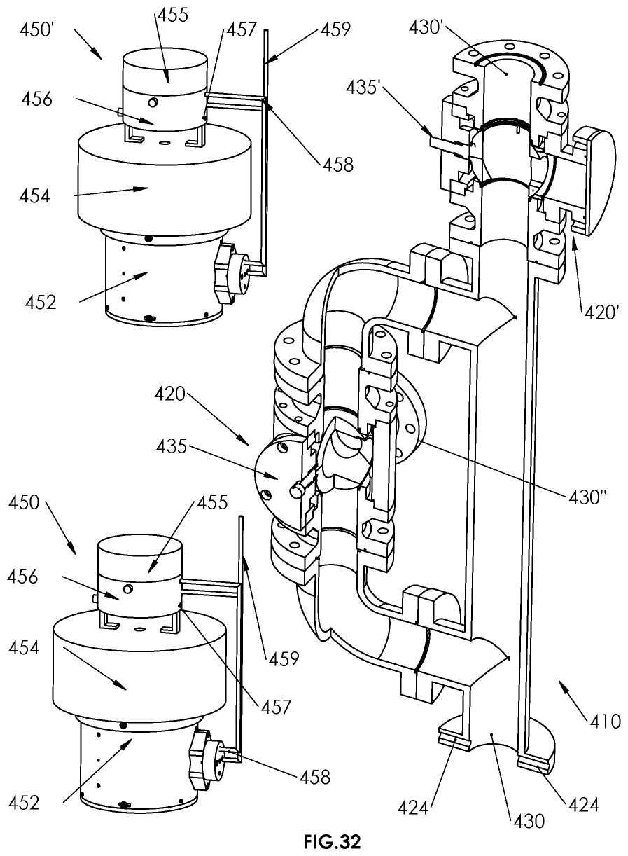

Referring FIG. 32, a pressure protection system 410 has an isolating subsystem 420′ and a releasing subsystem 420, the system 410 has an inlet 430, an outlet 430′ and release port 430″ and sensing sections 424, the isolating subsystem 420′ has a normally open valve 435′ and a thermal actuation subsystem 450′ for isolating flows from the inlet 430′, the thermal actuation subsystem 450′ has a control chamber 454 connected with a sensing section 424 for sensing incoming flows from the inlet 430 (a tubing not shown) and deciding actions with a vane actuator module 452 coupled with normally open valve 435′, a power supply assembly 455 connected with the control chamber 454 for supplying actuating fluids, the releasing subsystem 420 has a normally closed valve 435 and a thermal actuation subsystem 450 for releasing flows into the releasing port 430″ from the inlet 430, the thermal actuation subsystem 450 has the control chamber 454 connected with the sensing section 424 for sensing incoming flows from the inlet 430 (a tubing not shown) and deciding actions with the vane actuator module 452 couple with normally closed valve 435 and the power supply assembly 455 connected with the control chamber 454 for supplying actuating fluids.

### Conclusions

The present invention provides a long sought solution—an inherent high leakage at corners as well as top and bottom faces of the vanes actuators the solution is (1) the removable top and bottom vane covers are designed to change the dynamic seals between the shaft vanes and housing flanges to static seals between shaft vanes and the covers to eliminate any dynamic leaks on the shaft and provides easy assembly and increase shaft vanes strength with top and bottom cover supports and reduce the housing weights by removing bolting holes on the housing (2) corner seal rings provides directly solution instead of avoiding the corner seal issue, the seal rings made out of the thermal polymer plastics provide evenly compressed sealing surfaces to each corner of the vanes, stationery wall vanes, rotational shaft vanes (3) the vanes with two complete circumference seal rings, the vane not only greatly reduce cost unlike conventional single vane actuator with multiple layer molded seals but also add redundant seals and pressure energized seals to prolong the seal ring life and increase the holding toque, so even after one of the seal rings wear out, the pressure still help provides good seals, the sealing is not only based on the interference but also the working pressure, the unique combination complete solves the century old problems for all vane actuators with much lower cost and much high reliability over all prior arts or all existing vane actuators around the world, moreover the vane can be constructed with control able magnetic property, so each of housing vanes is constructed as N pole, while each of the shaft vanes is constructed with S pole (4) top and bottom pressure equalized groove on the housing vanes with or without sealant, so the grooves catch crossover fluid during the vanes are rotating and seal off at statistic seals, those features make the vane actuator to compete with the other rotary actuators like rack pinion or helical actuates for precision positions control at much low cost and much high reliability with a one moving part without linear and rotary motion converting.

The differential rotation mechanism is other disruptive innovation, it breaks the limitation of rotation beyond 360 degree for the first time in history of the vane actuator, although the vane actuators is one of the oldest rotary actuators, the differential rotation mechanism put the vane actuator at the same capability as the rack pion actuator or helical actuator but at much lower cost, each set of the drive assemblies will add additional rotation angles 90 or more for applications of diverting three way ball valves with 90 degree and 180 degree without any positioner control, 180, 270 and 360 degree are no longer be constrained for vane actuators, unlike rack pinion or helical actuators which would be bigger and larger due to the linear/rotary converting mechanism get more larger and heavier, as the angle increases, each set of the drive assemblies is disposed in concentric manner, balanced radially from the center axial to outward and can be constructed with the housing assembly with one level down as one integral unit or a two modules assembled unit, each drive assembly is well interconnected with others in item of porting and structures without additional tubing or parts, the foundational difference is the each of drive assemblies to create a relative rotation movement from prior one, they can be control by each independent porting system or by one combined porting system, those features greatly open the control field for more complicated applications which are impossible for most rotary actuators, the full stroke actuator test is impossible to conduct in any existing rotary actuator without affect valve operation condition, so instead the partial stroke test was introduced, the partial stroke test is a fault test but the best fault test with current actuation technology, the full stroke test is conducted with two set drive vanes with 90 degree rotation, if each drive subassembly is controlled independently, if first one rotate +90 degree, the second one rotates −90, the result is 90-90=0, even a valve operation condition does not change, the actuator is fully tested between 0-90 degree, other application is 90+90=180 degree rotation, two of the conventional vane actuators are constructed with an additional tubing, adapters and fixtures, big misalignment, but the differential rotation mechanism can accomplish the work with two drive subassemblies controlled to create a relative rotation, 90+90=180, for fast operation, if each drive sub assembly rotates 45 degree, 45+45=90 for open operations or 45-45=0 for closed operations, it takes a half time in comparison with the all conventional rotary actuator, it can finally compete against helical actuators in term of structure integrity and simplicity as well as cost.

The porting system is other innovation for versatile porting system ever developed for complicated actuation applications, the sealing rings and the differential rotation mechanism and the porting system are the three pillars for the 21 first century vane actuation, they work together to break all inherent barrier and to overcome difficulty of the challenging applications, it includes the axial porting subsystem, the center porting system and radial porting system, they can work together as redundancy or as an individual system, the axial porting subsystem provides a compact, dynamic porting method between the flange assembly and the cover unlike the conventional axial porting subsystem which are static porting system, it is well used for air return reservoir without external tuning or bolts and also is an important porting system for inter-porting among actuation modules for 2 D or 3 D motion control, as well as for top and bottom fluid entry applications, moreover the porting system can be an integral of the cover with press fit or glue for internal fluid connection among the cavities, while radial porting subsystem or the axial porting subsystem is a key element of the differential rotation mechanism in the sequence control applications, it includes the novel L passes between the vane assemblies, finally the center porting subsystem is other one for both static and dynamic porting applications, when the housing assembly is moving, the drive assembly is stationed for applications like earth moving equipment and landing gears or just internal fluid connection among the cavities, finally the porting line can be double or triples or more like porting lines C, D, E, and F for the speech control, like fast closing operation less than 1 second, three or more porting lines may be used at beginning, only a port line may be used at near closing position, so such a control not only solve the speech issue, but also avoid high closing impact which is the main reason for the seat and packing damage of most fast shut off valves, with a second axial drive assembly as a turbocharger, almost 50% of releasing pressurized fluid from line port A or line port B can add more torque to drive the output shaft of any types of rotary actuators, so if it is used for air returner applications, the actuators work like a double acting actuator, both side actuations have the same output torques as well function like a fan to protect the actuator in high temperature applications by depleting the heat, moreover, it can be used to hold a position by blocking both port lines A and B.

The thermal actuation system provides a revolutionized solution for actuation system with basic thermal elements pressure sources, volume vessels and heat sources, unlike other systems like electrical or hydraulic power systems, the heat is bad for those system and waste energy and burn the wire or coils and cause shaft galling, even like gas over liquid actuators are widely used in gas pipelines for actuating line valves, but they are polluted air during actuating the valves, but this system has a safe way to burn nature gas as heat source by gas burner to increase the air temperature as well as pressure to power the valves in the gas pipeline, the system has gas burns nature to burn the gas, which is much clear in comparison with releasing low pressure nature gas on the gas over liquid actuators along with other heat sources like solar power to energize the electric heat tracing, further the air reservoir can be used at the bottom flange assembly as an insolation unit to protect the actuator for heat or cool fluid from those valves handling hot air in the jet or turbine engines or cryogenic fluid.

The universal adaptability of the vane actuator is another breakthrough for the wide range of applications, the spherical or conical flanges or housing joint would greatly increase holding capacity in any position like robotic 3 Dimensional or 2D motion actuators, three actuation modules would create a simple 3D robotic arm for replacing 16 linkages excavator control system, the satellite receiver or wind turbine control system, or weapon/heavy machinery system control, moreover the adaptability of the shaft joint for almost all ISO5211 connection selections or three pin joint is so universal that it can couple with any valve shaft joint like double D, key joint and square joint without an additional adapter, the adapter has the reliability and robustness of the joint and reduce possible of joint failure without backlash or loss of motion with various pins like dowel pin, coiled pins and spring pins or with pin with a preset strength as a safety device, if the load is reach the limit, the pin would be broken down for saving the actuator or driving objects or twisted as energy storing device to absorb the shock energy for most sudden closing operations along with the stop pads.

For first time, a separation between the relative position adjustment mechanism and the conventional absolute position adjustment is other disruptive innovation in this invention, most manufacturers or prior acts never even realize the difference between those two, this position adjustments for actuation system in this invention is divided into an absolute position adjustment and relative position adjustment, the conventional positions adjustment is based on an absolution position change between 0-90 or more, while for most operators in the field, a precision closed position is critical for all rotary valve, even 1 degree off can cause leak, but 99% of stem position adjustments are about the stem relative position to the joint flanges bolt holes with no need to alter a factory preset range 0-90 or 180+/−0.5 degree, only 1% of the actuation adjustments is an absolute adjustment between 0-90 or 180+/−5 or 10 degree, the relative positions adjustment is a simple solution to 99% problems, for further position security, anti-loosening washers or semi-permanent adhesive may be added with the bolts after setting a correct position, for 1% problems, the factory set 90+/−0.5 can be set at the factory with the stop pads, it along saves 60% time in most rotary actuations field calibration, moreover, the setscrews with high friction devices are used to secure a position between the flange and the drive assembly after adjustment as a redundancy beside the fastens, while the absolution position device is constructed with stop pads with the composite materials to absorb shock once they contact with each other, they are made at a preset angle in a factory with high precisions, in addition, the flange assembly and the cover together greatly reduce the housing materials without the thick wall for vertical bolting design as well as the shaft vane materials with think wall due to the cover reinforcement on the drive assembly and they make possible for the relative position adjustment, all the vane flanges in the prior arts are fixed not adjustable, the flange can be equipped with additional static seal rings for the housing assembly as a redundant seal, while the cover can be equipped with additional dynamic seal rings for the drivel assembly as a redundant seal.

The adjustable, inclusive, embedded shaft packing is other invocation with wide applications, first it not only provides additional shaft seals, but also increases the shaft side loading capacity by shifting the loading from the vane shaft to the packing area when the actuators installed in horizontal positions or between vertical and horizontal positions and controls precision rotation holding capacity based on various applications by increase the packing friction unlike the helical actuator come with inherent, uncontrollable high unnecessary converting frictions, which waste 30 to 60% of fluid power energy and wear out the actuators prematurely, meanwhile it overcomes the inherent vane actuator lower holding capacity due to no linear/rotary converting frictions, second the embedded adjustable locking mechanism does not interfere with the shaft joint or shaft coupling for wider coupling selections especially for two or more dimension rotation applications, third it can be used for pump shaft or valve shaft seals, 80% of automated valve come with conventional packing assembly, the conventional packing assembly includes the packing, top gland and bolts, and is main causes for those stem leakages, those causes include the misalignment between valve shaft and actuator shaft or excessive compression on the packing, while this packing system has no external gland and bolts and eliminate the adapter and coupling joint errors, moreover the eccentric plug has the highest and lowest with the bearing between 12' clock and 6' clock positions for compressing control, so users can easily find out the limit of the packing adjustment and replace the packing before the packing loses sealing function, the smartness of the packing play a key role in today fugitive emission control under government regulations around the world like EPA in U.S, especially from 2020, in US, the fugitive emission standard would be less than 100 ppm, finally this shaft packing can be replaced with very low cost, while the helical actuators with inherent high friction would not only damage the seal ring and mated parts prematurely, but also have high cost to make, repair and replace.

Although the description above contains many specifications, these should not be construed as limiting the scope of the invention but as merely providing illustration of some of the presently preferred embodiments of this invention.

Thus, the scope of the invention should be determined by the appended claims and their legal equivalents, rather than by the examples given.

I claim:

1) A fluid control system comprising:
(a) A piping assembly having at least one inlet section and at least one outlet section connected with a pipe and at least one release section and at least one sensing connection.
(b) A hybrid pressure control assembly has at least one pressure-isolating subsystem and at least one pressure-releasing control subsystem, said subsystem has at least one valve and at least one actuation system, said actuation system has at least one pressurized power source, at least one volume vessel and at least one heat source, said pressurized power source has one of a plurality of forms including a pressurized fluid supply line and a compressor, said compressor is powered by one of a plurality of forms including AC power lines, DC power lines and solar power units, said volume vessel includes one of a plurality of forms including a local volume vessel and a center volume vessel, said heat source has one of a plurality of forms including a solar heat, an electric heater, a gas heater, a steam heater and a fire burner, said actuation system also has at least one rotary actuation module.

2) The fluid control system of claim 1, wherein said rotary actuation module has at least one housing assembly, at least one drive assembly disposed in said housing assembly and at least one porting system embedded between said housing assembly and said drive assembly, said housing assembly has a housing and at least two external corner seal rings and two flange assemblies and at least one housing vane assembly installed with said housing for providing reactionary torques, said housing has at least two external seal grooves respectively to receive said external seal ring, said housing vanes assembly has a housing vane and at least two housing vane seal rings, said housing vane has at least one top slot and at least one bottom slot which are a means for providing pressure equalized zone to minimize and prevent leakages and at least two edge grooves respectively for receiving said housing vane seal ring for sealing and expanding to multiple side holes which are a means for providing pressure energized seals, said drive assembly has a shaft assembly and at least one shaft vane assembly and two removable covers respectively disposed on said shaft vane assembly and said housing van assembly, said shaft vane has at least two shaft vane seal rings, at least two edge grooves respectively for receiving said shaft vane seal ring which are a means for providing edge seals and expanding to multiple side holes which are a means for providing pressure energized seals, said shaft assembly has a shaft and at least two internal corner seal rings and at least two internal corner grooves respectively to receive said internal corner seal ring, said shaft had a one of a plurality of confirmations including said shaft having at least one output adapter and said shaft having no output adapter, said housing vane also have two internal corner radii respectively engaged with said internal corner seal ring which are a means for providing corner seals and two external corner radii respectively engaged with said external corner seal ring which are a means for providing corner seals, said shaft vane also have two internal corner mated radii respectively engaged with said internal corner seal ring which are a means for providing corner seals and two external corner mated radii respectively engaged with said external corner seal ring which are a means for providing corner seals.

3) The fluid control system of claim 2, wherein said porting system has at least one of a plurality of confirmations including (1) at least one central porting system installed in the drive assembly has a cylinder and a porting line A′ and porting line B′, said porting line A has a port A″, port A″′ and a link groove A and at least two link holes respectively connected to at least said shaft vane assembly into cavities between said housing vane assemblies and said shaft vane assemblies, said porting line B has a port B″, port B′″ and a link groove B and at least two like holes B respectively connected to at least cavities between said housing vane assemblies and said shaft vane assemblies, said central porting system has a retainer ring secured a rotary joint with said drive assembly (2) at least one axial porting system installed between said flange assembly and sais cover has a porting line A′ and porting line B′, said porting line A has a port A′ and at least one link groove A and two like holes respectively connected to at least cavities between said housing vane assemblies and said shaft vane assemblies, said porting line B has at least one port B′ and at least one link groove B and at least two like holes B respectively connected to at least two cavities between said housing vane assemblies and said shaft vane assemblies (3) at least one radial porting system embedded between said housing assembly and at least one said drive assembly has one of plurality arrangements including (a) at least one external porting assembly and a port line A and a port line B, said external link ring assembly has a link groove A1 and at least two link holes connected with said link groove A1 into two cavities between said housing vane assemblies and said shat vane assemblies at a second drive assembly, said port line A has a port AA expanding to said link groove A1 into said cavities A between said housing vane assemblies and said shaft vane assemblies, said port line A has link holes A1 respectively constructed on said shaft vane assemblies at a second drive assembly expanding to said housing vane assemblies in a first drive assembly, said port line B has link holes B1 respectively constructed on said shaft vane assemblies at a second drive assembly expanding to said housing vane assemblies in a first drive assembly (b) at least one external link porting assembly, a port line A and a port line B, said external link ring assembly has a link groove A2 having a porting section and an acting section and two link holes respectively connected with said porting section and said acting section, a link groove B2 having a porting section and an acting section and at least two link holes respectively connected with said porting section and said acting section, said port line A has a port AA1 connected to said porting section of link groove A2 and a first cavity between said housing vane assemblies and said shat vane assemblies at a second drive assembly connected with said porting section, a link port constructed on one of said shaft vane assembly expanding to said housing vane assembly into a first cavity in a first drive assembly, said port line A has also a port AA2 connected to said acting section of link groove A2 and a second cavity between said housing vane assemblies and said shat vane assemblies at a second drive assembly, said port line B also has a port BB1 connected to said porting section of link groove B2 and a first cavity between said housing vane assemblies and said shat vane assemblies at said second drive assembly connected with said porting section, a link port constructed on one of said shaft vane assembly expanding to said housing vane assembly into a second cavity in said first drive assembly, said port line B has also a port BB 2 connected to said acting section of link groove B2 and a second cavity between said housing vane assemblies and said shat vane assemblies at said second drive assembly.

4) The fluid control system of claim 2, wherein said actuation module has at least one relative position adjustable device, at least one absolute position adjustable device and at least one shaft adapter, said relative position device assembly has a slot, a friction device and a screw hole on said housing assembly and a setscrew hole on said flange assembly and a fastener assembly having inserted into said slot and said screw hole and a setscrew screwed into said setscrew hole penetrated into said friction device on said body assembly against said flange assembly which are a means for providing locking and unlocking said relative positions, said friction device has one of plurality forms including coatings, knurling surfaces, dents, a solid ring embed into said body assembly under said setscrew, said absolute position adjustable device has at a pair of stop pads having one of said stop pads constructed with said housing vane assembly and one of said stop pads constructed with said shaft vane assembly for limiting a rotation of said drive assembly at a preset value, said shaft adapter assembly has one of a plurality of configurations including (a) said adapter having at least two external pin slots and at least two external pins disposed between said shaft and said adapter and at least two internal pin slots for pin joints (b) said adapter having at least two external pin slots and at least two external pins disposed between said shaft and said adapter and at least two internal pin slots and at least two setscrew sets for Double D and square Heads joints (c) said adapter having at least two external pin slots and at least two external pins disposed between said shaft and said adapter and at least two key/pin devices for keyway joints.

5) The fluid control system of claim 2, wherein said actuation module has at least one shutter valve, said shutter valve has at least one inlet port and one outlet port, a body assembly, a shutter assembly movably disposed in said body assembly and an adjustable back seat assembly and a set of spring biased between said shutter assembly and said adjustable back seat assembly, said adjustable back seat assembly has a head defined by one of a plurality of forms including conical surfaces and spherical surfaces, said body assembly has a body having a shutter bore extended to a front hole and a back bore and a front seal ring assembly disposed between said body assembly and said shutter assembly for front seals and a back seal ring assembly disposed between said adjustable back seat assembly and said shutter assembly for back seals, said shutter assembly has a seal ring, a shutter disposed in said shutter bore having a head, a center hole extended to front multiple radial ports and a back end defined by multiple fluid slots and a back sealing surface against said back seal ring assembly for seals, said back sealing surface has one of a plurality of configurations including conical surfaces and spherical surfaces, said head has one of a plurality of configurations including (a) an extended tip with a seal ring and a front sealing surface against said front seal ring assembly for providing front seals (b) a front sealing surface against said front seal ring for providing front seals, said front sealing surface has one of a plurality of forms including conical surfaces and spherical surfaces.

6) The fluid control system of claim 2, wherein said actuation module has at least one shaft packing assembly in a stuff box of said flange assembly, said shaft assembly has an adjustable bearing assembly and a packing set under said adjustable bearing assembly, said adjustable bearing assembly has a bearing having a shaft bore to receive said shaft assembly and at least two horizontal slots, at least two eccentric plugs and at least two fasteners to secure said plugs at an adjusted position and two retainer rings to secure said plugs at an adjusted position, each of two eccentric plugs has a drive section disposed in a hole of said flange assembly and an eccentric section engaged with said horizontal slot for moving said bearing up and down against said packing set.

7) The thermal actuation system of claim 2, wherein said actuation module has said external fluid ring assembly, said housing assembly and said flange assembly, said external fluid ring assembly has one of plurality of profiles including spherical surfaces, conical surface and cylindrical surfaces, said flange assembly has one of plurality of profiles including spherical surfaces, conical surfaces and flat surface, said housing assembly has one of plurality of profiles including spherical surfaces and conical surfaces, cylindrical surfaces.

8) A thermal actuation system has at least one pressurized power source, at least one volume vessel and at least one heat source, said pressurized power source has one of a plurality of forms including a pressurized fluid supply line and a compressor, said compressor is powered by one of a plurality of forms including AC power lines, DC power lines and solar power units, said volume vessel includes one of a plurality of forms including a local volume vessel and a center volume vessel, said heat source has one of a plurality of forms including a solar heat, an electric heater, a gas heater, a steam heater and a fire burner, said thermal actuation system also has at least one rotary actuation module.

9) The thermal actuation system of claim 8, wherein said rotary actuation module has at least one housing assembly, at least one drive assembly disposed in said housing assembly and at least one porting system embedded between said housing assembly and said drive assembly, said housing assembly has a housing and at least two external corner seal rings and two flange assemblies and at least one housing vane assembly installed with said housing for providing reactionary torques, said housing has at least two external seal grooves respectively to receive said external seal ring, said housing vanes assembly has a housing vane and at least two housing vane seal rings, said housing vane has at least one top slot and at least one bottom slot which are a means for providing pressure equalized zone to minimize and prevent leakages and at least two edge grooves respectively for receiving said housing vane seal ring for sealing and expanding to multiple side holes which are a means for providing pressure energized seals, said drive assembly has a shaft assembly and at least one shaft vane assembly and two removable covers respectively disposed on said shaft vane assembly and said housing van assembly, said shaft vane has at least two shaft vane seal rings, at least two edge grooves respectively for receiving said shaft vane seal ring which are a means for providing edge seals and expanding to multiple side holes which are a means for providing pressure energized seals, said shaft assembly has a shaft and at least two internal corner seal rings and at least two internal corner grooves respectively to receive said internal corner seal ring, said shaft had a one of a plurality of confirmations including said shaft having at least one output adapter and said shaft having no output adapter, said housing vane also have two internal corner radii respectively engaged with said internal corner seal ring which are a means for providing corner seals and two external corner radii respectively engaged with said external corner seal ring which are a means for providing corner seals, said shaft vane also have two internal corner mated radii respectively engaged with said internal corner seal ring which are a means for providing corner seals and two external corner mated radii respectively engaged with said external corner seal ring which are a means for providing corner seals.

10) The thermal actuation system of claim 9, wherein said porting system has at least one of a plurality of confirmations including (1) at least one central porting system installed in the drive assembly has a cylinder and a porting line A′ and porting line B′, said porting line A has a port A″, port A″′ and a link groove A and at least two link holes respectively connected to at least said shaft vane assembly into cavities between said housing vane assemblies and said shaft vane assemblies, said porting line B has a port B″, port B′″ and a link groove B and at least two like holes B respectively connected to at least cavities between said housing vane assemblies and said shaft vane assemblies, said central porting system has a retainer ring secured a rotary joint with said drive assembly (2) at least one axial porting system installed between said flange assembly and sais cover has a porting line A′ and porting line B′, said porting line A has a port A′ and at least one link groove A and two like holes respectively connected to at least cavities between said housing vane assemblies and said shaft vane assemblies, said porting line B has at least one port B′ and at least one link groove B and at least two like holes B respectively connected to at least two cavities between said housing vane assemblies and said shaft vane assemblies (3) at least one radial porting system embedded between said housing assembly and at least one said drive assembly has one of plurality arrangements including (a) at least one external porting assembly and a port line A and a port line B, said external link ring assembly has a link groove A1 and at least two link holes connected with said link groove A1 into two cavities between said housing vane assemblies and said shat vane assemblies at a second drive assembly, said port line A has a port AA expanding to said link groove A1 into said cavities A between said housing vane assemblies and said shaft vane assemblies, said port line A has link holes A1 respectively constructed on said shaft vane assemblies at a second drive assembly expanding to said housing vane assemblies in a first drive assembly, said port line B has link holes B1 respectively constructed on said shaft vane assemblies at a second drive assembly expanding to said housing vane assemblies in a first drive assembly (b) at least one external link porting assembly, a port line A and a port line B, said external link ring assembly has a link groove A2 having a porting section and an acting section and two link holes respectively connected with said porting section and said acting section, a link groove B2 having a porting section and an acting section and at least two link holes respectively connected with said porting section and said acting section, said port line A has a port AA1 connected to said porting section of link groove A2 and a first cavity between said housing vane assemblies and said shat vane assemblies at a second drive assembly connected with said porting section, a link port constructed on one of said shaft vane assembly expanding to said housing vane assembly into a first cavity in a first drive assembly, said port line A has also a port AA2 connected to said acting section of link groove A2 and a second cavity between said housing vane assemblies and said shat vane assemblies at a second drive assembly, said port line B also has a port BB1 connected to said porting section of link groove B2 and a first cavity between said housing vane assemblies and said shat vane assemblies at said second drive assembly connected with said porting section, a link port constructed on one of said shaft vane assembly expanding to said housing vane assembly into a second cavity in said first drive assembly, said port line B has also a port BB 2 connected to said acting section of link groove B2 and a second cavity between said housing vane assemblies and said shat vane assemblies at said second drive assembly.

11) The thermal actuation system of claim 9, wherein said actuation module has at least one relative position adjustable device, at least one absolute position adjustable device and at least one shaft adapter, said relative position device assembly has a slot, a friction device and a screw hole on said housing assembly and a setscrew hole on said flange assembly and a fastener assembly having inserted into said slot and said screw hole and a setscrew screwed into said setscrew hole penetrated into said friction device on said body assembly against said flange assembly which are a means for providing locking and unlocking said relative positions, said friction device has one of plurality forms including coatings, knurling surfaces, dents, a solid ring embed into said body assembly under said setscrew, said absolute position adjustable device has at a pair of stop pads having one of said stop pads constructed with said housing vane assembly and one of said stop pads constructed with said shaft vane assembly for limiting a rotation of said drive assembly at a preset value, said shaft adapter assembly has one of a plurality of configurations including (a) said adapter having at least two external pin slots and at least two external pins disposed between said shaft and said adapter and at least two internal pin slots for pin joints (b) said adapter having at least two external pin slots and at least two external pins disposed between said shaft and said adapter and at least two internal pin slots and at least two setscrew sets for Double D and square Heads joints (c) said adapter having at least two external pin slots and at least two external pins disposed between said shaft and said adapter and at least two key/pin devices for keyway joints.

12) The thermal actuation system of claim 9, wherein said actuation module has at least one shutter valve, said shutter valve has at least one inlet port and one outlet port, a body assembly, a shutter assembly movably disposed in said body assembly and an adjustable back seat assembly and a set of spring biased between said shutter assembly and said adjustable back seat assembly, said adjustable back seat assembly has a head defined by one of a plurality of forms including conical surfaces and spherical surfaces, said body assembly has a body having a shutter bore extended to a front hole and a back bore and a front seal ring assembly disposed between said body assembly and said shutter assembly for front seals and a back seal ring assembly disposed between said adjustable back seat assembly and said shutter assembly for back seals, said shutter assembly has a seal ring, a shutter disposed in said shutter bore having a head, a center hole extended to front multiple radial ports and a back end defined by multiple fluid slots and a back sealing surface against said back seal ring assembly for seals, said back sealing surface has one of a plurality of configurations including conical surfaces and spherical surfaces, said head has one of a plurality of configurations including (a) an extended tip with a seal ring and a front sealing surface against said front seal ring assembly for providing front seals (b) a front sealing surface against said front seal ring for providing front seals, said front sealing surface has one of a plurality of forms including conical surfaces and spherical surfaces.

13) The thermal actuation system of claim 9, wherein said actuation module has at least one shaft packing assembly in a stuff box of said flange assembly, said shaft packing assembly has an adjustable bearing assembly and a packing set under said adjustable bearing assembly, said adjustable bearing assembly has a bearing having a shaft bore to receive said shaft assembly and at least two horizontal slots, at least two eccentric plugs and at least two fasteners to secure said plugs at an adjusted position and two retainer rings to secure said plugs at an adjusted position, each of two eccentric plugs has a drive section disposed in a hole of said flange assembly and an eccentric section engaged with said horizontal slot for moving said bearing up and down against said packing set.

14) The thermal actuation system of claim 9, wherein said actuator module has said external fluid ring assembly, said housing assembly and said flange assembly, said external fluid ring assembly has one of plurality of profiles including spherical surfaces, conical surface and cylindrical surfaces, said flange assembly has one of plurality of profiles including spherical surfaces, conical surfaces and flat surface, said housing assembly has one of plurality of profiles including spherical surfaces, conical surfaces and cylindrical surfaces.

15) An actuation module has at least one housing assembly, at least one drive assembly disposed in said housing assembly and at least one porting system embedded between said housing assembly and said drive assembly, said housing assembly has a housing and at least two external corner seal rings and two flange assemblies and at least one housing vane assembly installed with said housing for providing reactionary torques, said housing has at least two external seal grooves respectively to receive said external seal ring, said housing vanes assembly has a housing vane and at least two housing vane seal rings, said housing vane has at least one top slot and at least one bottom slot which are a means for providing pressure equalized zone to minimize and prevent leakages and at least two edge grooves respectively for receiving said housing vane seal ring for sealing and expanding to multiple side holes which are a means for providing pressure energized seals, said drive assembly has a shaft assembly and at least one shaft vane assembly and two removable covers respectively disposed on said shaft vane assembly and said housing van assembly, said shaft vane has at least two shaft vane seal rings, at least two edge grooves respectively for receiving said shaft vane seal ring which are a means for providing edge seals and expanding to multiple side holes which are a means for providing pressure energized seals, said shaft assembly has a shaft and at least two internal corner seal rings and at least two internal corner grooves respectively to receive said internal corner seal ring, said shaft had a one of a plurality of confirmations including said shaft having at least one output adapter and said shaft having no output adapter, said housing vane also have two internal corner radii respectively engaged with said internal corner seal ring which are a means for providing corner seals and two external corner radii respectively engaged with said external corner seal ring which are a means for providing corner seals, said shaft vane also have two internal corner mated radii respectively engaged with said internal corner seal ring which are a means for providing corner seals and two external corner mated radii respectively engaged with said external corner seal ring which are a means for providing corner seals.

16) The actuation module claim 15, wherein said porting system has at least one of a plurality of confirmations including (1) at least one central porting system installed in the drive assembly has a cylinder and a porting line A′ and porting line B′, said porting line A has a port A″, port A″′ and a link groove A and at least two link holes respectively connected to at least said shaft vane assembly into cavities between said housing vane assemblies and said shaft vane assemblies, said porting line B has a port B″, port B′″ and a link groove B and at least two like holes B respectively connected to at least cavities between said housing vane assemblies and said shaft vane assemblies, said central porting system has a retainer ring secured a rotary joint with said drive assembly (2) at least one axial porting system installed between said flange assembly and sais cover has a porting line A′ and porting line B′, said porting line A has a port A′ and at least one link groove A and two like holes respectively connected to at least cavities between said housing vane assemblies and said shaft vane assemblies, said porting line B has at least one port B′ and at least one link groove B and at least two like holes B respectively connected to at least two cavities between said housing vane assemblies and said shaft vane assemblies (3) at least one radial porting system embedded between said housing assembly and at least one said drive assembly has one of plurality arrangements including (a) at least one external porting assembly and a port line A and a port line B, said external link ring assembly has a link groove A1 and at least two link holes connected with said link groove A1 into two cavities between said housing vane assemblies and said shat vane assemblies at a second drive assembly, said port line A has a port AA expanding to said link groove A1 into said cavities A between said housing vane assemblies and said shaft vane assemblies, said port line A has link holes A1 respectively constructed on said shaft vane assemblies at a second drive assembly expanding to said housing vane assemblies in a first drive assembly, said port line B has link holes B1 respectively constructed on said shaft vane assemblies at a second drive assembly expanding to said housing vane assemblies in a first drive assembly (b) at least one external link porting assembly, a port line A and a port line B, said external link ring assembly has a link groove A2 having a porting section and an acting section and two link holes respectively connected with said porting section and said acting section, a link groove B2 having a porting section and an acting section and at least two link holes respectively connected with said porting section and said acting section, said port line A has a port AA1 connected to said porting section of link groove A2 and a first cavity between said housing vane assemblies and said shat vane assemblies at a second drive assembly connected with said porting section, a link port constructed on one of said shaft vane assembly expanding to said housing vane assembly into a first cavity in a first drive assembly, said port line A has also a port AA2 connected to said acting section of link groove A2 and a second cavity between said housing vane assemblies and said shat vane assemblies at a second drive assembly, said port line B also has a port BB1 connected to said porting section of link groove B2 and a first cavity between said housing vane assemblies and said shat vane assemblies at said second drive assembly connected with said porting section, a link port constructed on one of said shaft vane assembly expanding to said housing vane assembly into a second cavity in said first drive assembly, said port line B has also a port BB 2 connected to said acting section of link groove B2 and a second cavity between said housing vane assemblies and said shat vane assemblies at said second drive assembly.

17) The actuation module claim 15, wherein said actuation module has at least one relative position adjustable device, at least one absolute position adjustable device and at least one shaft adapter, said relative position device assembly has a slot, a friction device and a screw hole on said housing assembly and a setscrew hole on said flange assembly and a fastener assembly having inserted into said slot and said screw hole and a setscrew screwed into said setscrew hole penetrated into said friction device on said body assembly against said flange assembly which are a means for providing locking and unlocking said relative positions, said friction device has one of plurality forms including coatings, knurling surfaces, dents, a solid ring embed into said body assembly under said setscrew, said absolute position adjustable device has at a pair of stop pads having one of said stop pads constructed with said housing vane assembly and one of said stop pads constructed with said shaft vane assembly for limiting a rotation of said drive assembly at a preset value, said shaft adapter assembly has one of a plurality of configurations including (a) said adapter having at least two external pin slots and at least two external pins disposed between said shaft and said adapter and at least two internal pin slots for pin joints (b) said adapter having at least two external pin slots and at least two external pins disposed between said shaft and said adapter and at least two internal pin slots and at least two setscrew sets for Double D and square Heads joints (c) said adapter having at least two external pin slots and at least two external pins disposed between said shaft and said adapter and at least two key/pin devices for keyway joints.

18) The actuation module claim 15, wherein said actuation module has at least one shutter valve, said shutter valve has at least one inlet port and one outlet port, a body assembly, a shutter assembly movably disposed in said body assembly and an adjustable back seat assembly and a set of spring biased between said shutter assembly and said adjustable back seat assembly, said adjustable back seat assembly has a head defined by one of a plurality of forms including conical surfaces and spherical surfaces, said body assembly has a body having a shutter bore extended to a front hole and a back bore and a front seal ring assembly disposed between said body assembly and said shutter assembly for front seals and a back seal ring assembly disposed between said adjustable back seat assembly and said shutter assembly for back seals, said shutter assembly has a seal ring, a shutter disposed in said shutter bore having a head, a center hole extended to front multiple radial ports and a back end defined by multiple fluid slots and a back sealing surface against said back seal ring assembly for seals, said back sealing surface has one of a plurality of configurations including conical surfaces and spherical surfaces, said head has one of a plurality of configurations including (a) an extended tip with a seal ring and a front sealing surface against said front seal ring assembly for providing front seals (b) a front sealing surface against said front seal ring for providing front seals, said front sealing surface has one of a plurality of forms including conical surfaces and spherical surfaces.

19) The actuation module claim 15, wherein said actuation module has at least one shaft packing assembly in a stuff box of said flange assembly, said shaft packing assembly has an adjustable bearing assembly and a packing set under said adjustable bearing assembly, said adjustable bearing assembly has a bearing having a shaft bore to receive said shaft assembly and at least two horizontal slots, at least two eccentric plugs and at least two fasteners to secure said plugs at an adjusted position and two retainer rings to secure said plugs at an adjusted position, each of two eccentric plugs has a drive section disposed in a hole of said flange assembly and an eccentric section engaged with said horizontal slot for moving said bearing up and down against said packing set.

20) The actuation module claim 15, wherein said actuation module has said external fluid ring assembly, said housing assembly and said flange assembly, said external fluid ring assembly has one of plurality of profiles including spherical surfaces, conical surface and cylindrical surfaces, said flange assembly has one of plurality of profiles including spherical surfaces, conical surfaces and flat surface, said housing assembly has one of plurality of profiles including spherical surfaces, conical surfaces and cylindrical surfaces.
